(19) United States
(12) Patent Application Publication
(10) Pub. No.: US 2010/0291330 A1
(43) Pub. Date: Nov. 18, 2010

(54) HOUSING AND METHOD OF MANUFATURING THE SAME

(75) Inventors: JEN-HONG HSU, Tu-Cheng (TW); HAI-LIN CHEN, Shenzhen City (CN); YU-GUO ZHANG, Shenzhen City (CN); YONG YANG, Shenzhen City (CN); JUN ZENG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/534,238

(22) Filed: Aug. 3, 2009

(30) Foreign Application Priority Data
May 14, 2009 (CN) 200910302313.1

(51) Int. Cl. B32B 1/02; B05D 3/06

(52) U.S. Cl. 428/35.7; 427/555

(57) ABSTRACT

A housing for an electronic device includes a plastic base, a prime layer, a decorative layer, and a transparent protection layer. The prime layer is coated on the plastic base, and defines a pattern embedded in the prime layer. The decorative layer is coated on the prime layer and the pattern. The decorative layer has a light reflective capability, and a thickness of the decorative layer is less than a depth of the pattern. The transparent protection layer is coated on the decorative layer.

### BACKGROUND

1. Technical Field

The present disclosure generally relates to device housings and, particularly to a housing for an electronic device and a method of manufacturing the housing.

2. Description of Related Art

Electronic devices such as notebook computers, MP3 players, personal digital assistants, and mobile phones are in common use. A pleasing appearance and finish, such as a metallic finish, are often important to users.

Accordingly textured patterns or stripes are often formed on the exterior housing of such devices. However, such textured patterns or stripes are often integrally formed with a color coating layer on the exterior housing of the electronic device. If the textured patterns or stripes are the same color and configuration as the color coating layer, the textured patterns or stripes may be difficult to discern, thus the appearance of the electronic device may be less appealing than is desired.

Therefore, what is needed is a housing that overcomes the limitations described.

### BRIEF DESCRIPTION OF THE DRAWINGS

The components in the drawing are not necessarily drawn to scale, the emphasis instead being placed upon clearly illustrating the principles of the present disclosure.

FIG. 1 is a cross-section of a portion of an embodiment of a housing.

FIG. 2 is a flowchart of an embodiment of a method of manufacturing the housing in FIG. 1.

### DETAILED DESCRIPTION

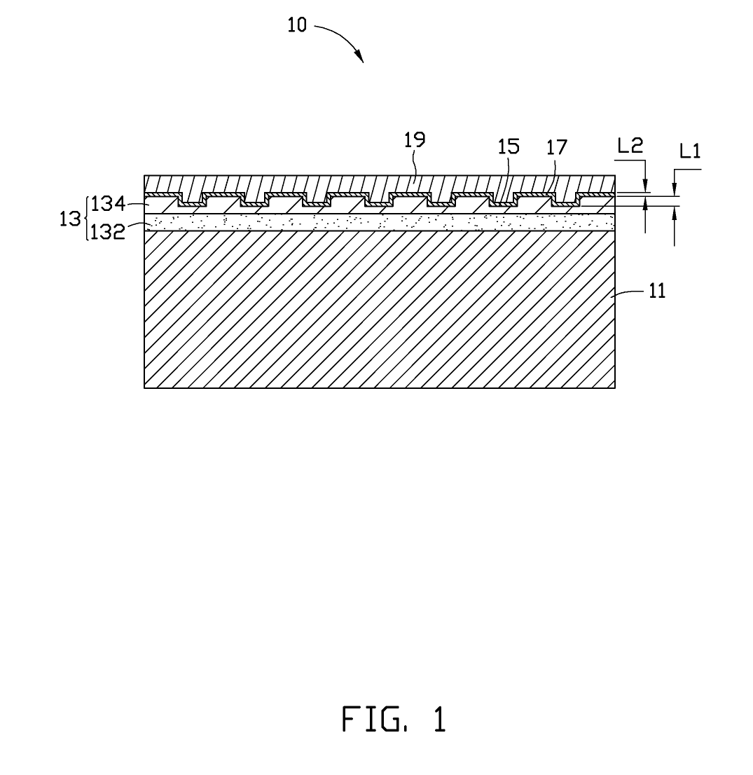

Referring to FIG. 1, an embodiment of a housing 10 includes a plastic base 11, a prime layer 13, a decorative layer 17, and a transparent protection layer 19. The prime layer 13, the decorative layer 17, and the transparent protection layer 19 are coated on the plastic base 11 in order. The prime layer 13 defines a pattern 15 embedded therein.

The plastic base 11 may be acrylonitrile butadiene styrene (ABS), polycarbonate (PC), polyphenylene sulphide (PPS), or any suitable combination thereof.

The prime layer 13 improves a coating performance of the plastic base 11. In the illustrated embodiment, the prime layer 13 includes a connecting layer 132 adjacent to the plastic base 11, and a color coating layer 134 coated on the connecting layer 132.

The connecting layer 132 masks surface defects of the plastic base 11, and enhances bonding between the color coating layer 134 and the plastic base 11. The connecting layer 132 may include acrylic resin, polyester resin, epoxy resin, amino resin, acrylate copolymer, propylene glycol methyl ether acetate (PMA), butyl ester, and pigments dispersed therein. The pigments may be carbon black, exhibiting favorable absorption of laser energy. The thickness of the connecting layer 132 may be about 15 micrometers (μm) to about 20 μm.

The color coating layer 134 normalizes the surface of the plastic base 11. The color coating layer 134 may include acrylic resin, polyester resin, epoxy resin, amino resin, acrylate copolymer, PMA, butyl ester, and pigments dispersed therein. The pigments may be any desired color. The thickness of the color coating layer 134 may be about 15 μm to about 80 μm.

The pattern 15 is defined in the color coating layer 134 via laser engraving. The pattern 15 embedded in the color coating layer 134 has a depth L1.

The decorative layer 17 has light reflective capability. The decorative layer 17 may include acrylic resin, polyester resin, epoxy resin, amino resin, acrylate copolymer, PMA, butyl ester, pigments, and aluminum oxide powder dispersed therein. The pigments and the aluminum oxide powder may be in a nanometer scale. The aluminum oxide powder provides metallic luster to the housing 10, and generates a light reflective effect. The pigments may be any desired color. The decorative layer 17 has a thickness L2. The L2 may be about 2 μm to about 7 μm and less than the depth L1. Thus, the decorative layer 17 is evenly coated on the color coating layer 134 and the pattern 15.

The transparent protection layer 19 protects the decorative layer 17 and the pattern 15 from abrasion, and improves glossiness of the housing 10. The transparent protection layer 19 may include acrylic resin, polyester resin, epoxy resin, amino resin, silicon dioxide, acrylate copolymer, PMA, and butyl ester. The thickness of the transparent protection layer 19 may be about 20 μm to about 80 μm.

The decorative layer 17 is evenly coated on the top surfaces of the color coating layer 134, the side surfaces, and the bottom surfaces of the pattern 15, because the thickness L2 of the decorative layer 17 is less than the depth L1 of the pattern 15. The top surfaces of the color coating layer 134, the side surfaces, and the bottom surfaces of the pattern 15 have different light reflective effects, due to the differences in the light input quantity and light reflection angles. Thus, the pattern 15 has a visual effect different from the color coating layer 134, so that the pattern 15 is clearly defined in the color coating layer 134. In addition, the visual difference between the pattern 15 and the color coating layer 134 is enhanced by the transparent protection layer 19, rendering the pattern 15 even more clearly discernible in the color coating layer 134. Furthermore, when viewed from different aspects, the pattern 15 may show different colors, due to the light reflection of the decorative layer 17 and the light refraction of the transparent protection layer 19. The decorative layer 17 also provides metallic luster to the housing 10, giving the housing 10 a pleasing appearance.

Alternatively, if the plastic base 11 has only minimal surface defects, the connecting layer 132 may be omitted, and the color coating layer 134 can be directly coated on the plastic base 11, or the color coating layer 134 may be omitted, and the pattern 15 can be defined in the connecting layer 132.

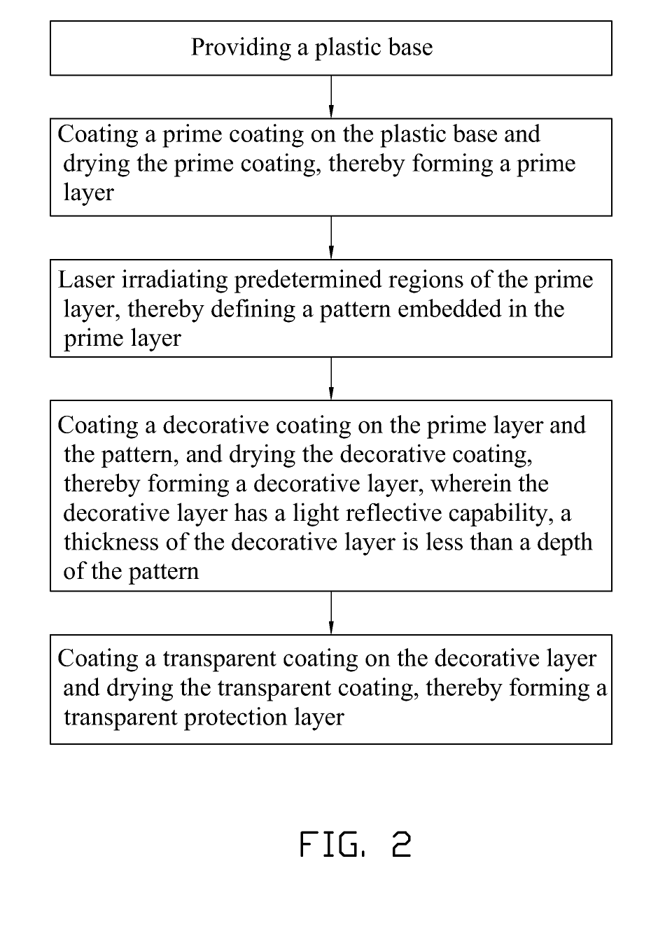

Referring to FIG. 2, an embodiment of a method of manufacturing a housing 10 is also provided.

A plastic base 11 may be manufactured by injection molding.

A prime layer 13 is coated on the plastic base 11. The prime layer 13 includes a connecting layer 132 and a color coating layer 134. A connecting coating is coated on the plastic base 11 and dried, thereby forming the connecting layer 132. A color coating is then coated on the connecting layer 132 and dried, thereby forming the color coating layer 134. The connecting coating may include acrylic resin, polyester resin, epoxy resin, amino resin, acrylate copolymer, PMA, butyl ester, and pigments dispersed therein. The connecting coating may be coated on the plastic base 11 by spray coating. A drying temperature of the connecting coating is about 50 degrees Celsius (° C.) to about 100° C. A drying time of the connecting coating is from about 10 minutes to about 30 minutes. The color coating may include acrylic resin, polyester resin, epoxy resin, amino resin, acrylate copolymer, PMA, butyl ester, and pigments dispersed therein. The color coating may be coated on the connecting layer 132 by spray coating. A drying temperature of the color coating is 5 about 0° C. to about 100° C. A drying time of the color coating is about 10 minutes to about 30 minutes.

The plastic base 11 is received in a laser engraver, and predetermined regions of the color coating layer 134 are engraved. The materials of the color coating layer 134 at the predetermined regions disintegrate due to energy of the laser, thus defining a pattern 15 in the color coating layer 134. The power of the laser is adjusted to control the depth of the pattern 15.

A decorative coating is coated on the color coating layer 134 and the pattern 15 and dried, thereby forming a decorative layer 17. The thickness of the decorative layer 17 is less than the depth L1 of the pattern 15. The decorative coating may include acrylic resin, polyester resin, epoxy resin, amino resin, acrylate copolymer, PMA, butyl ester, pigments and aluminum oxide powder dispersed therein. The decorative coating may be coated on the color coating layer 134 and the pattern 15 by spray coating. A drying temperature of the decorative coating is about 50° C. to about 100° C. A drying time of the decorative coating is about 10 minutes to about 30 minutes.

A transparent coating is coated on the decorative layer 17 and dried, thereby forming a transparent protection layer 19. The transparent coating may include acrylic resin, polyester resin, epoxy resin, amino resin, silicon dioxide, acrylate copolymer, PMA, and butyl ester. The transparent coating may be coated on the decorative layer 17 by spray coating. A drying temperature of the transparent coating is about 50° C. to about 100° C. A drying time of the transparent coating is about 10 minutes to about 30 minutes.

Alternatively, the connecting layer 132 may be omitted, and the color coating layer 134 can be directly coated on the plastic base 11, or the color coating layer 134 may be omitted, and the pattern 15 can be defined in the connecting layer 132.

In one embodiment of the method of manufacturing a housing 10, a plastic base 11 is made of ABS by injection molding. A connecting coating is coated on the plastic base 11 and dried for about 30 minutes, at about 50° C., thus forming a connecting layer 132 about 20 μm thick. A laser is irradiated on the predetermined regions of the connecting layer 132, thus defining a pattern 15 in the connecting layer 132. A decorative coating is coated on the connecting layer 132 and the pattern 15, and dried for about 10 minutes, at about 100° C., thus forming a decorative layer 17. The thickness L2 of the decorative layer 17 is about 2 μm, less than the depth L1 of the pattern 15. Finally, a transparent coating is coated on the decorative layer 17 and dried for about 10 minutes, at about 100° C., thus forming a transparent protection layer 19 about 50 μm thick.

In another embodiment of the method of manufacturing a housing 10, a plastic base 11 is made of PC by injection molding. A color coating is coated on the plastic base 11 and dried for about 10 minutes, at about 100° C., thus forming a color coating layer 134 about 25 μm thick. A laser is irradiated on the predetermined regions of the color coating layer 134, thus defining a pattern 15 in the color coating layer 134. A decorative coating is coated on the color coating layer 134 and the pattern 15, and dried for about 15 minutes, at about 80° C., thus forming a decorative layer 17. The thickness L2 of the decorative layer 17 is about 5 μm, less than the depth L1 of the pattern 15. Finally, a transparent coating is coated on the decorative layer 17 and dried for about 30 minutes, at about 50° C., thus forming a transparent protection layer 19 about 80 μm thick.

In yet another embodiment of the method of manufacturing a housing 10, a plastic base 11 is made of ABS and PC by injection molding. A connecting coating is coated on the plastic base 11 and dried for about 10 minutes, at about 100° C., thus forming a connecting layer 132 about 15 μm thick. A color coating is coated on the connecting layer 132 and dried for about 30 minutes, at about 50° C., thus forming a color coating layer 134 about 50 μm thick. A laser is irradiated on the predetermined regions of the color coating layer 134, thus defining a pattern 15 in the color coating layer 134. A decorative coating is coated on the color coating layer 134 and the pattern 15, and dried for about 30 minutes, at about 50° C., thus forming a decorative layer 17. The thickness L2 of the decorative layer 17 is about 7 μm, less than the depth L1 of the pattern 15. Finally, a transparent coating is coated on the decorative layer 17 and dried for about 15 minutes, at about 80° C., thus forming a transparent protection layer 19 about 20 μm thick.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A housing for an electronic device, comprising:
a plastic base;
a prime layer coated on the plastic base, the prime layer defining a pattern embedded therein;
a decorative layer coated on the prime layer and the pattern; and
a transparent protection layer coated on the decorative layer;
wherein the decorative layer has a light reflective capability, and a thickness of the decorative layer is less than a depth of the pattern.

2. The housing of claim 1, wherein the prime layer comprises a connecting layer coated on the plastic base, and a color coating layer coated on the connecting layer; the pattern is defined in the color coating layer.

3. The housing of claim 1, wherein the plastic base is selected from the group consisting of acrylonitrile butadiene styrene, polycarbonate, polyphenylene sulphide, and any suitable combination thereof.

4. The housing of claim 2, wherein the connecting layer comprises a material selected from the group consisting of acrylic resin, polyester resin, epoxy resin, amino resin, acrylate copolymer, propylene glycol methyl ether acetate, butyl ester, and any suitable combination thereof; the connecting layer also comprises pigments dispersed therein.

5. The housing of claim 4, wherein the pigments of the connecting layer are carbon black.

6. The housing of claim 2, wherein the color coating layer comprises a material selected from the group consisting of acrylic resin, polyester resin, epoxy resin, amino resin, acrylate copolymer, propylene glycol methyl ether acetate, butyl ester, and any suitable combination thereof; the color coating layer also comprises pigments dispersed therein.

7. The housing of claim 1, wherein the decorative layer comprises a material selected from the group consisting of acrylic resin, polyester resin, epoxy resin, amino resin, acrylate copolymer, propylene glycol methyl ether acetate, butyl ester, and any suitable combination thereof; the decorative layer also comprises pigments and aluminum oxide powder dispersed therein.

8. The housing of claim 7, wherein the pigments and the aluminum oxide powder of the decorative layer are in a nanometer scale.

9. The housing of claim 1, wherein the transparent protection layer comprises a material selected from the group consisting of acrylic resin, polyester resin, epoxy resin, amino resin, acrylate copolymer, propylene glycol methyl ether acetate, butyl ester, and any suitable combination thereof; the transparent protection layer also comprises silicon dioxide dispersed therein.

10. The housing of claim 1, wherein the pattern is defined in the prime layer via laser engraving.

11. The housing of claim 2, wherein the thickness of the connecting layer is about 15 μm to about 20 μm, the thickness of the color coating layer is about 15 μm to about 80 μm, the thickness of the decorative layer is about 2 μm to about 7 μm, the thickness of the transparent protection layer is about 20 μm to about 80 μm.

12. A housing for an electronic device, comprising:
a plastic base;
a color coating layer coated on the plastic base, the color coating layer defining a pattern embedded therein; and
a decorative layer coated on the color coating layer and the pattern, the decorative layer comprising aluminum oxide powder to provide metallic luster to the housing and to generate a light reflective effect, a thickness of the decorative layer being less than a depth of the pattern.

13. The housing of claim 12, further comprising a connecting layer coated on the plastic base, and the color coating layer is coated on the connecting layer.

14. The housing of claim 12, further comprising a transparent protection layer coated on the decorative layer.

15. The housing of claim 12, wherein the pattern is defined in the color coating layer via laser engraving.

16. A method of manufacturing a housing for an electronic device, comprising:
providing a plastic base;
coating a prime coating on the plastic base and drying the prime coating, thereby forming a prime layer;
laser irradiating predetermined regions of the prime layer, thereby defining a pattern embedded in the prime layer;
coating a decorative coating on the prime layer and the pattern, and drying the decorative coating, thereby forming a decorative layer, wherein the decorative layer has a light reflective capability, a thickness of the decorative layer is less than a depth of the pattern; and
coating a transparent coating on the decorative layer and drying the transparent coating, thereby forming a transparent protection layer.

17. The method of manufacturing a housing of claim 16, wherein the prime layer comprises a connecting layer coated on the plastic base, and a color coating layer coated on the connecting layer; a connecting coating is coated on the plastic base and dried, thereby forming the connecting layer, a color coating is then coated on the connecting layer and dried, thereby forming the color coating layer.

18. The method of manufacturing a housing of claim 17, wherein a drying temperature of the connecting coating is about 50° C. to about 100° C., a drying time of the connecting coating is about 10 minutes to about 30 minutes; a drying temperature of the color coating is about 50° C. to about 100° C., and a drying time of the color coating is about 10 minutes to about 30 minutes.

19. The method of manufacturing a housing of claim 16, wherein a drying temperature of the decorative coating is about 50° C. to about 100° C., and a drying time of the decorative coating is about 10 minutes to about 30 minutes.

20. The method of manufacturing a housing of claim 16, wherein a drying temperature of the transparent coating is about 50° C. to about 100° C., and a drying time of the transparent coating is about 10 minutes to about 30 minutes.
